(19) United States
(12) Patent Application Publication
(10) Pub. No.: US 2026/0246763 A1
(43) Pub. Date: Aug. 20, 2026

(54) Privacy-Preserving Vehicle Communication Framework for Seamless Stakeholder Engagement

(71) Applicant: Gopichandra Surnilla, West Bloomfield, MI (US)

(72) Inventor: Gopichandra Surnilla, West Bloomfield, MI (US)

(21) Appl. No.: 19/054,881

(22) Filed: Feb. 16, 2025

(51) Int. Cl. H04L 9/40; G07B 15/06; G08G 1/0967; G08G 1/16; H04W 4/40

(52) U.S. Cl. CPC H04L 63/0407; G08G 1/096766; H04W 4/40; G07B 15/06; G08G 1/16

(57) ABSTRACT

A system for enabling privacy-preserving communication using vehicle identifiers is disclosed. The system includes a central computing platform configured to receive a communication request including a vehicle identifier, determine a communication endpoint based on contextual data including vehicle state and location information, perform identifier translation using anonymized tokens, and transmit a message without exposing personal identifiers. The system supports bidirectional communication between external devices, vehicle communication modules, and user-associated devices. The architecture enables applications including parking, tolling, safety alerts, and cooperative vehicle operation while maintaining privacy and improving communication efficiency.

### FIELD OF THE INVENTION

This invention relates to computer-implemented communication systems for connected vehicles, and more particularly to systems and methods for enabling privacy-preserving communication between external entities and vehicles using vehicle identifiers and dynamic routing mechanisms. The invention further relates to enabling privacy-preserving communication between external entities and vehicles using vehicle identifiers and dynamic routing mechanisms. The invention specifically addresses challenges and opportunities present within this evolving technical area, focusing on methods that prioritize privacy-preserving communication to improve the user experience.

### BACKGROUND OF THE INVENTION

The transportation landscape is experiencing a profound transformation driven by technological advancements such as cloud computing, sensing systems, artificial intelligence (AI), machine learning (ML), and enhanced connectivity. This technological revolution has led to the comprehensive digitization of transportation systems, with a focus on improving safety, efficiency, autonomy, and data-driven analytics. A critical aspect of this paradigm shift is the integration of cameras into transportation infrastructure, which has enabled a wide range of applications in vehicle safety, automated driving, and intelligent traffic management.

Among these applications, the Automated License Plate Reader (ALPR) system has emerged as a pivotal technology for tasks such as parking management, toll collection, and traffic regulation. While ALPR systems significantly enhance operational efficiency, they present a notable drawback: the ability to extract personal details about vehicle owners, including addresses, from license plate data. Consequently, traditional methods for communicating with vehicle owners—such as notifying them of toll charges via postal mail—are not only expensive but also result in substantial time delays, sometimes extending from two weeks to two months.

In certain cases, vehicle owners may be given the option to download a dedicated mobile application to streamline communication; however, this method has its limitations. Users must navigate multiple distinct apps for various service providers, and the requirement to disclose personal information, such as phone numbers, raises concerns regarding the exposure of personally identifiable information (PII). As a result, these restrictions hinder the widespread adoption of ALPR systems and limit their potential applications.

To address the limitations of current ALPR systems and the privacy concerns associated with existing mobile app-based solutions, this invention proposes a method to establish a secure link between vehicle license plate information and cellular identification, ensuring individual privacy is preserved. Furthermore, the proposed architecture allows a single mobile application to serve multiple functions across different services within a city or state—such as managing parking and tolling transactions—unlocking a wide array of new use cases that were previously unattainable with existing systems. While this invention outlines several exemplary use cases to illustrate its operational aspects, it is crucial to note that these represent only a fraction of the potential applications, positioning this innovation as a foundational element poised to drive further advancements in the field.

### SUMMARY OF THE INVENTION

The present invention provides a computer-implemented communication system and method for enabling privacy-preserving communication using vehicle identifiers. The system includes a central computing platform comprising one or more processors, memory, and network interfaces configured to process communication requests associated with vehicle identifiers.

The central computing platform is configured to receive a communication request including a vehicle identifier, query a registration database to identify one or more communication endpoints associated with the vehicle identifier, and perform identifier translation to generate an anonymized communication token distinct from the vehicle identifier and personal identifiers.

The system further includes a routing decision module (implemented within the central computing platform) configured to determine a target communication endpoint based on contextual data including vehicle operational state, driver presence, geospatial location, and communication policy constraints.

The central computing platform is further configured to transmit a message to the determined communication endpoint using the anonymized communication token, thereby enabling communication without exposing personally identifiable information.

In some embodiments, the communication endpoint includes a user-associated communication device, a vehicle-associated communication module, or both. The system supports bidirectional communication through session-based routing using the anonymized communication token.

In some embodiments, the system performs a unified registration process associating a vehicle identifier with multiple communication endpoints using a single transaction.

In some embodiments, the system utilizes geospatial correlation between a vehicle location and a communication device location to validate communication relevance and improve routing accuracy.

The system enables applications including parking management, tolling, safety alerts, cooperative vehicle operation, and transactional communication, while maintaining privacy through separation of vehicle identifiers and communication identifiers.

### BRIEF DESCRIPTION OF THE DRAWINGS

FIG. 1 illustrates the system architecture.

FIG. 2 illustrates the vehicle registration process.

FIG. 3 illustrates communication between Entity1 and Entity2 using a communication identifier.

FIG. 4 illustrates communication between Entity1 and Entity2.

FIG. 5 illustrates communication between Entity1 and a vehicle communication module.

### DETAILED DESCRIPTION OF THE INVENTION

### Objects of the Invention

An object of the invention is to facilitate communication between a requesting entity and at least one of a user-associated communication device [40] or a vehicle-associated communication module [50] using a vehicle identifier.

Another object is to enable communication between external systems and vehicle-associated users through a central computing platform [60], utilizing vehicle identifiers as a basis for message routing.

Another object is to enable communication between external systems and a vehicle-associated communication module [50], thereby supporting vehicle-based notifications and interactions.

Another object is to enable communication between a requesting entity and a user associated with a vehicle without requiring direct exchange of personal contact information.

Another object is to support both one-way and two-way communication between a requesting entity and at least one communication endpoint associated with a vehicle.

Another object is to facilitate anonymized communication by translating a vehicle identifier into a communication identifier via a central computing platform [60].

Another object is to provide a registration process for associating a vehicle identifier with at least one communication endpoint, including a user-associated communication device [40] and/or a vehicle-associated communication module [50].

Another object is to determine a target communication endpoint based on contextual information, including vehicle state, user availability, and communication intent.

Another object is to enable communication routing to a user-associated communication device [40] when user interaction is required and to a vehicle-associated communication module when vehicle interaction is required.

Another object is to support location-based verification and contextual communication using location-related information associated with a vehicle or user device.

Another object is to enable communication between multiple vehicles or systems while preserving anonymity through mediated communication.

Another object is to support transaction-related communication, including tolling, parking, or other location-based services.

Another object is to provide notification and alert mechanisms associated with vehicle-related events while preserving user privacy.

### Description of the Invention

The invention relates to a method and system for enabling communication between a requesting entity (Entity1) [30] and at least one of a user-associated communication device (Entity2) [40] or a vehicle-associated communication module (Entity2Veh) [50] via a central computing platform [60], while preserving anonymity through the use of a communication identifier.

### Concept Architecture

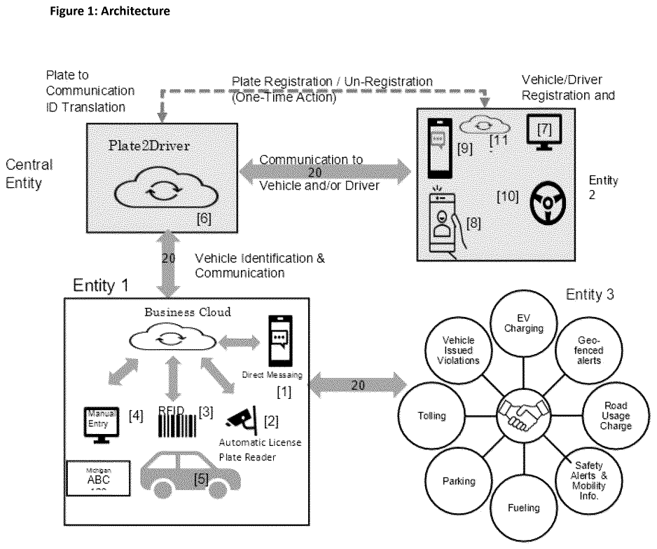

FIG. 1 illustrates a system architecture for a privacy-preserving vehicle communication system. The system comprises a plurality of interconnected components configured to enable communication between external entities and vehicles or associated users using vehicle identifiers.

A requesting computing device [30] (also referred to as Entity1) is configured to capture or input a vehicle identifier. The requesting computing device [30] may include, for example, an automatic license plate recognition (ALPR) system, an RFID reader, or a manual input interface.

A central computing platform [60] is communicatively coupled to the requesting computing device [30], one or more user-associated communication devices [40], and one or more vehicle-associated communication modules [50]. The central computing platform [60] comprises one or more processors, non-transitory memory, and network interfaces.

The central computing platform [60] further includes a registration database configured to store associations between vehicle identifiers and communication endpoints, an identifier translation module configured to generate anonymized communication tokens, and a message routing module (also referred to as a routing decision module) configured to transmit messages to selected communication endpoints. The anonymized communication token [20] represents a communication identifier generated by the central computing platform [60] that is distinct from the vehicle identifier.

A user-associated communication device [40] (also referred to as Entity2) corresponds to a user associated with the vehicle and is configured to send and receive messages via a communication network.

A vehicle-associated communication module [50] (also referred to as Entity2Veh) is integrated within a vehicle and is configured to receive messages and optionally present information via an in-vehicle interface or perform vehicle-related actions.

A communication network facilitates data exchange among the requesting computing device [30], the central computing platform [60], the user-associated communication device [40], and the vehicle-associated communication module [50].

In operation, the requesting computing device [30] transmits a vehicle identifier to the central computing platform [60]. The central computing platform [60] performs identifier translation and determines a target communication endpoint based on contextual data, and transmits a message using an anonymized communication token [20] to at least one of the user-associated communication device [40] or the vehicle-associated communication module [50].

### System Operational Details

The system facilitates communication between a requesting entity (Entity1) [30] and at least one of a user-associated communication device (Entity2) [40] or a vehicle-associated communication module (Entity2Veh) [50] via the central computing platform [60]. Transmission of information is dependent on contextual factors, including vehicle state, message type, and communication objectives.

In various embodiments, communication may be directed to the vehicle-associated communication module [50], the user-associated communication device [40], or both. For example, when the vehicle is in active use or when in-vehicle interaction is required, communication may be directed to the vehicle-associated communication module [50]. When user awareness or action is required outside the vehicle, communication may be directed to the user-associated communication device [40].

The central computing platform [60] determines an appropriate communication endpoint associated with a vehicle identifier based on information received from Entity1 [30], vehicle context, and system policies. Such determination may include selecting between the user-associated communication device [40], the vehicle-associated communication module [50], or both.

In some embodiments, the central computing platform [60] utilizes a communication identifier to facilitate anonymized communication between Entity1 [30] and Entity2 [40] and/or Entity2Veh [50], thereby enabling message routing without exposing direct contact information.

The system supports a variety of use cases employing the architecture described herein.

Individual Messaging the Vehicle Owner: Entity 1 [30] transmits a message including a vehicle identifier to the central computing platform [60]. The central computing platform [60] identifies a communication endpoint associated with the vehicle identifier and transmits the message to the user-associated communication device [40].

System Messaging Vehicle Owner (Parking): A system such as an automatic license plate recognition (ALPR) system captures a vehicle identifier and transmits parking-related information to the central computing platform [60], which routes the information to the user-associated communication device [40] and/or the vehicle-associated communication module [50].

Automated Parking Enforcement: The system evaluates parking conditions and transmits enforcement-related information, including potential violations or penalties, via the central computing platform [60] to at least one communication endpoint associated with the vehicle identifier.

System Messaging Vehicle Owner (Tolling): The central computing platform [60] receives vehicle identification information corresponding to a toll event and transmits toll-related information to the user-associated communication device [40] and/or the vehicle-associated communication module [50].

Connected Vehicle Safety: The system transmits safety-related alerts, including potential collision warnings or hazard notifications, to the vehicle-associated communication module [50] and/or the user-associated communication device [40].

Connected Vehicle Control: The system may transmit control-related messages, including traffic or infrastructure-based instructions, to the vehicle-associated communication module [50] for execution of vehicle-related functions.

Cooperative Vehicle Interaction: Vehicles or external systems associated with Entity 1 [30] may capture vehicle identifiers of nearby vehicles and transmit related information to the central computing platform [60], which facilitates anonymized communication with corresponding user-associated communication devices [40] or vehicle-associated communication modules [50].

These use cases illustrate the flexibility of the system in enabling communication, transaction processing, and safety-related interactions while preserving privacy through mediated communication.

### System Architecture and Processing

The central computing platform [60] executes a structured process for enabling privacy-preserving communication between a requesting entity (Entity1) [30] and at least one of a user-associated communication device (Entity2) [40] or a vehicle-associated communication module (Entity2Veh) [50].

The process comprises:
(a) receiving, from a requesting computing device [30], vehicle identification data associated with a vehicle;
(b) validating the vehicle identification data against a registration database;
(c) retrieving at least one communication endpoint associated with the vehicle identification data, the communication endpoint corresponding to at least one of a user-associated communication device [40] or a vehicle-associated communication module [50];
(d) determining a target communication endpoint based on contextual information and communication criteria;
(e) generating a communication identifier that is distinct from the vehicle identification data;
(f) transmitting a message to the determined communication endpoint using the communication identifier; and
(g) optionally receiving a response and routing the response to the requesting computing device [30].

In some embodiments, determining the target communication endpoint includes evaluating one or more contextual factors, including:
(i) vehicle state;
(ii) user availability;
(iii) communication intent; and
(iv) location-based information.

The process enables context-aware communication while preserving anonymity by utilizing a communication identifier in place of direct identifying information.

### DETAILED DESCRIPTION OF THE DRAWINGS

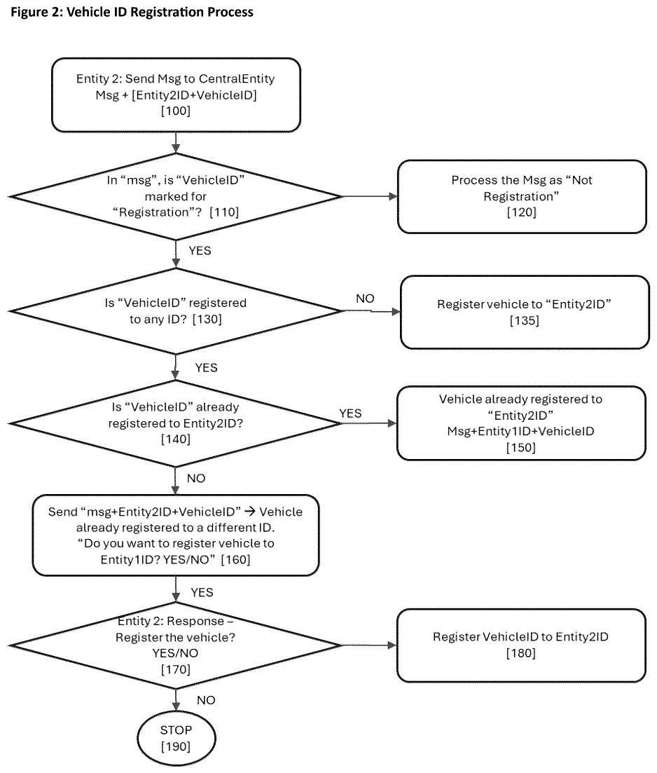

FIG. 1 and FIG. 2 detail the procedure for registering a vehicle's ID to the Vehicle Owner's communication ID.

Referring to FIG. 2, a process for registering a vehicle identifier with the central computing platform [60] is illustrated. The process may be initiated by a user or system associated with a vehicle.

The process begins at a start state and proceeds to capturing a vehicle identifier [200]. The vehicle identifier may include, for example, a license plate number, RFID, VIN, or other unique identifier associated with a vehicle.

A determination is made as to whether the vehicle identifier has been successfully captured. If the vehicle identifier is not captured or is invalid, the system may deny the request [204], and the process terminates.

If the vehicle identifier is successfully captured, the vehicle identifier is transmitted to the central computing platform [60] [202].

The central computing platform [60] determines whether the vehicle identifier is already registered in a registration database [208].

If the vehicle identifier is not registered, the central computing platform [60] registers the vehicle identifier and associates it with one or more communication endpoints [210].

Upon successful registration, a confirmation is generated and transmitted [212], and the process proceeds to an end state.

In some embodiments, if the vehicle identifier is already registered, the central computing platform [60] may validate the existing association and optionally confirm the registration without modification.

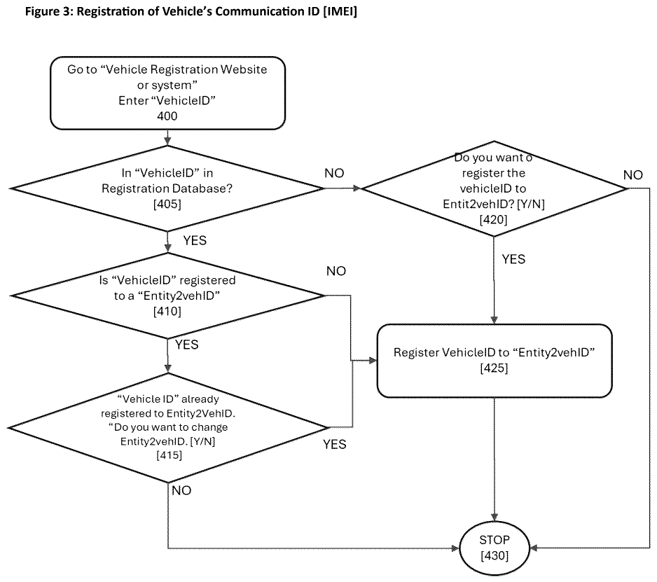

Referring to FIG. 3, a process for enabling communication between a requesting entity (Entity1) and a user-associated entity (Entity2) via a central computing platform [60] is illustrated.

The process begins at a start state, where Entity1 transmits a message including a vehicle identifier to the central computing platform [60] [300].

The central computing platform [60] determines whether the vehicle identifier is registered in a registration database [310]. If the vehicle identifier is not registered, the process may terminate or an error response may be generated.

If the vehicle identifier is registered, the central computing platform [60] assigns a communication identifier associated with the vehicle identifier [315], enabling anonymized communication between Entity1 and Entity2.

The central computing platform [60] transmits the message to Entity2 using the communication identifier [320].

Entity2 may generate a response to the message [340], which is transmitted to the central computing platform [60]. The communication between Entity1 and Entity2 may be asynchronous and may support one-way or two-way communication.

The central computing platform [60] routes the response received from Entity2 to Entity 1 using the communication identifier [345].

The process then proceeds to an end state.

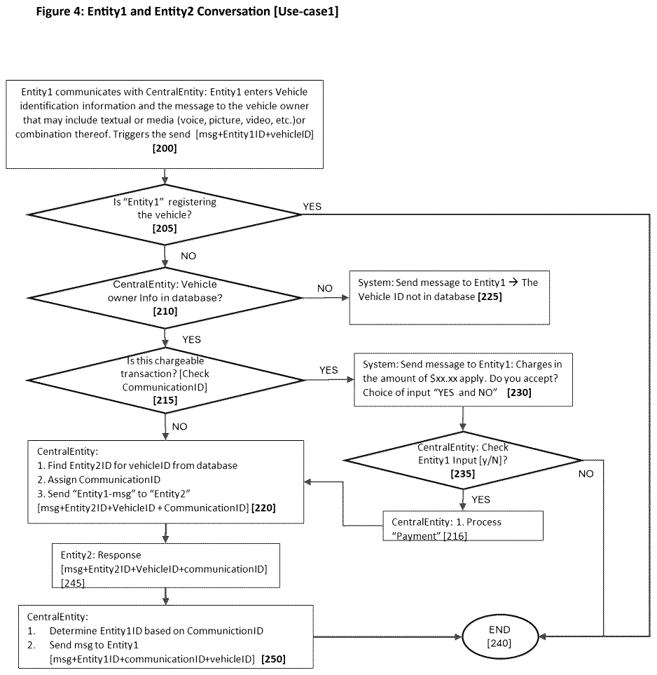

Referring to FIG. 4, a process for facilitating communication and transaction handling between a requesting entity (Entity1) [30], a central computing platform [60], and a user-associated entity (Entity2) [40] is illustrated.

The process begins when Entity1 [30] transmits a message including a vehicle identifier to the central computing platform [60] [400].

The central computing platform [60] determines whether the vehicle identifier is present in a registration database. If the vehicle identifier is not found, the central computing platform [60] transmits an error message to Entity1 [30] indicating that the vehicle identifier is not registered [425], and the process terminates.

If the vehicle identifier is present in the database, the central computing platform [60] determines whether a transaction or charge is associated with the communication request.

If a charge applies, the central computing platform [60] transmits a charge request message to Entity1 [30], including transaction details [430], and receives an input indicating acceptance or rejection.

If the charge is not accepted, the process may terminate. If the charge is accepted, the central computing platform [60] processes the payment associated with the communication request [416].

Following payment processing, or if no charge is required, the central computing platform [60] identifies a communication endpoint associated with Entity2 [40] and transmits the message to Entity2 [40] [420].

Entity2 [40] may generate a response message [445], which is transmitted to the central computing platform [60].

The central computing platform [60] determines the originating Entity1 [30] and routes the response message back to Entity 1 [30] [450].

The process then proceeds to an end state.

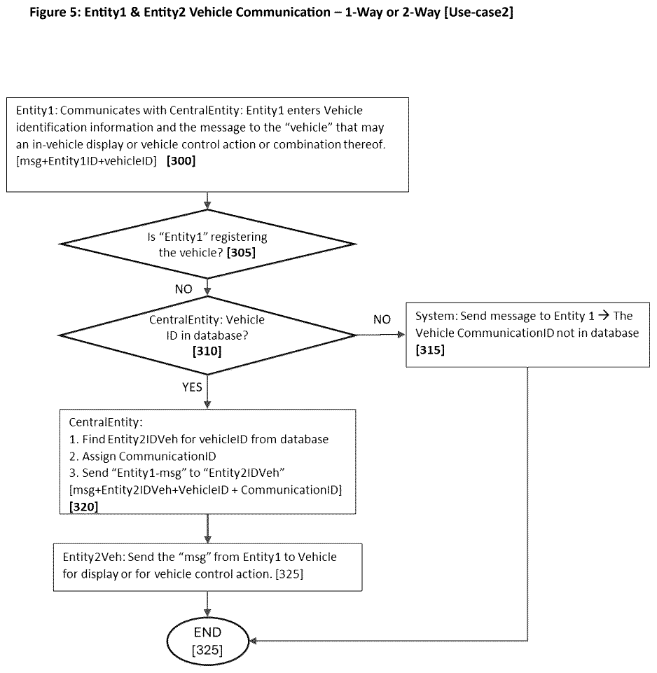

Referring to FIG. 5, a process for enabling communication between a requesting entity (Entity1) [30] and a vehicle-associated communication module (Entity2Veh) [50] via a central computing platform [60] is illustrated.

The process begins when Entity1 [30] transmits a message including a vehicle identifier to the central computing platform [60] [500].

The central computing platform [60] determines whether the vehicle identifier is registered in a registration database [510].

If the vehicle identifier is not registered, the central computing platform [60] transmits an error message to Entity1 [30] indicating that the vehicle identifier is not recognized [515], and the process terminates.

If the vehicle identifier is registered, the central computing platform [60] identifies a communication endpoint associated with the vehicle-associated communication module (Entity2Veh) [50] [520].

The central computing platform [60] transmits the message to Entity2Veh [50] using the identified communication endpoint [525].

The vehicle-associated communication module (Entity2Veh) [50] receives and processes the message, which may result in at least one of display, notification, or execution of a vehicle-related function.

The process then proceeds to an end state.

1. A computer-implemented communication system comprising:
a central computing platform comprising one or more processors, non-transitory memory storing executable instructions, and one or more network interfaces;
a registration database storing associations between vehicle identifiers and a plurality of communication endpoints, wherein the vehicle identifiers are maintained in a domain separate from communication endpoint identifiers;
a routing decision module executed by the one or more processors;
a requesting computing device configured to capture vehicle identification data and transmit a communication request;
a user-associated communication device corresponding to at least one of the communication endpoints;
and a vehicle-associated communication module configured to receive a transmitted message;
wherein the one or more processors are configured to:
(a) receive, from the requesting computing device, the communication request comprising a vehicle identifier;
(b) query the registration database to identify one or more communication endpoints associated with the vehicle identifier; (c) determine, using the routing decision module, a target communication endpoint based on one or more of vehicle state, location information, communication policy constraints, or user availability;
(d) perform identifier translation by generating an anonymized communication token distinct from the vehicle identifier and any personally identifiable information; and
(e) transmit a message to the determined communication endpoint via a communication network using the anonymized communication token.

2. The system of claim 1, wherein the central computing platform stores the registration database in a distributed or cloud-based storage system and enforces privacy policies during identifier resolution.

3. The system of claim 1, wherein the requesting computing device comprises an automatic license plate recognition system including an imaging sensor, a processor configured to execute optical character recognition, and a communication interface.

4. The system of claim 1, wherein the central computing platform routes a message from the requesting computing device to the user-associated communication device based on the vehicle identifier.

5. The system of claim 4, wherein the system enables bidirectional communication by routing a response message from the user-associated communication device to the requesting computing device.

6. The system of claim 1, wherein communication is performed using the vehicle identifier as a unified addressing mechanism independent of personal identifiers.

7. The system of claim 1, wherein when the vehicle is in an active state, the central computing platform selectively routes communication to at least one of the vehicle-associated communication module or the user-associated communication device.

8. The system of claim 1, wherein when the vehicle is in an inactive state, the central computing platform routes communication to a primary registered communication endpoint associated with a vehicle owner.

9. The system of claim 1, wherein the central computing platform performs a unified registration process associating the vehicle identifier with multiple communication endpoints using a single registration transaction.

10. The system of claim 1, wherein the central computing platform utilizes geospatial location data of the vehicle and a communication device associated with the vehicle to validate communication relevance and improve routing accuracy.

11. The system of claim 1, wherein the requesting computing device captures vehicle identifiers of surrounding vehicles and transmits intent-related data for cooperative vehicle operation.

12. The system of claim 1, wherein the system supports use cases including parking management, tolling, and vehicle safety communication.

13. The system of claim 1, wherein the central computing platform manages registration of the vehicle-associated communication module.

14. The system of claim 1, wherein the central computing platform executes identifier translation logic to map the vehicle identifier to a communication endpoint while preserving anonymity.

15. The system of claim 1, wherein the system further comprises a transaction processing system configured to process payments or feedback associated with the communication.

16. The system of claim 1, wherein the communication network comprises cellular infrastructure including wireless transceivers, switching systems, and cloud-based routing components.

17. The system of claim 1, wherein the central computing platform dynamically adjusts communication routing based on real-time geospatial data.

18. The system of claim 1, wherein the system enables communication between vehicles to exchange safety-related information including braking, lane changes, and merging.

19. The system of claim 1, wherein the requesting computing device determines vehicle dynamics and communicates intent information to support coordinated vehicle operations.
